(19) United States
(12) Patent Application Publication
(10) Pub. No.: US 2012/0223658 A1
(43) Pub. Date: Sep. 6, 2012

(54) LAMP AND LUMINAIRE WITH AT LEAST ONE LIGHT EMITTING DIODE

(75) Inventors: Stefan Otzen, Muenchen (DE); Fabian Reingruber, Muenchen (DE)

(73) Assignee: OSRAM AG, Muenchen (DE)

(21) Appl. No.: 13/410,323

(22) Filed: Mar. 2, 2012

(30) Foreign Application Priority Data
Mar. 3, 2011 (DE) 102011005051.5

(51) Int. Cl. H05B 41/38

(52) U.S. Cl. 315/307

(57) ABSTRACT

In various embodiments, a lamp is provided. The lamp may include at least one light emitting diode; a housing, which comprises at least a first housing part and a second housing part, wherein the first housing part is arranged movably relative to the second housing part; a motion detection sensor for detecting a magnitude of a movement of the first housing part relative to the second housing part; and a radiation modification apparatus for modifying at least one parameter of the radiation emitted by the at least one light emitting diode, the radiation modification apparatus being coupled to the motion detection sensor, the radiation modification apparatus being designed to modify the radiation to be emitted by the at least one light emitting diode depending on the detected magnitude of the movement.

### CROSS-REFERENCE TO RELATED APPLICATION

This application claims priority to German Patent Application Serial No. 102011005051.5, which was filed Mar. 3, 2011, and is incorporated herein by reference in its entirety.

### TECHNICAL FIELD

Various embodiments relate to a lamp with at least one LED and a housing, which includes at least a first housing part and a second housing part. Various embodiments also relate to a luminaire with at least one LED and a housing, which includes at least a first housing part and a second housing part.

### BACKGROUND

A lamp is understood to mean a replaceable unit which includes at least one light-emitting means and can be inserted into a luminaire. To this extent luminaires are available into which such a lamp can be inserted. Secondly, luminaires are known in which a light-emitting means is inserted permanently, i.e. not in the form of a replaceable lamp. Various embodiments described below relate to both lamps and luminaires of the last-mentioned type.

In the text which follows, the various embodiments and the prior art will be explained in more detail using the example of dimming of the at least one light emitting diode (LED). However, the invention also relates to other types of modification of at least one parameter of the radiation emitted by the at least one LED, as will be explained in more detail further below.

It is known from the prior art to actuate lamps and luminaires with at least one LED via an external switch. This switch often also includes a dimming function for the at least one LED. Unfortunately, this switch is often at a considerable distance or in an unfavorable position for an operator, however. In order to dim lamps and luminaires with at least one LED from any position, some manufacturers also offer products with remote control. In order for this function to be provided, however, the lamps and luminaires need to be in a standby mode. This is associated with an undesirably high power consumption. In addition, there is the problem with remote controls that it is often not possible to find them precisely when they are required.

### SUMMARY

In various embodiments, a lamp is provided. The lamp may include at least one light emitting diode; a housing, which comprises at least a first housing part and a second housing part, wherein the first housing part is arranged movably relative to the second housing part; a motion detection sensor for detecting a magnitude of a movement of the first housing part relative to the second housing part; and a radiation modification apparatus for modifying at least one parameter of the radiation emitted by the at least one light emitting diode, the radiation modification apparatus being coupled to the motion detection sensor, the radiation modification apparatus being designed to modify the radiation to be emitted by the at least one light emitting diode depending on the detected magnitude of the movement.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows schematic illustrations of various embodiments of a lamp in longitudinal section (FIG. 1a), along the section A-A from FIG. 1a (FIG. 1b), along the section B-B from FIG. 1a (FIG. 1c);

FIG. 2 shows schematic illustrations of various embodiments of a lamp in longitudinal section (FIG. 2a) and a perspective illustration along the section A-A from FIG. 2a (FIG. 2b);

FIG. 3 shows schematic illustrations of various embodiments of a lamp in an exploded illustration (FIG. 3a), in plan view with the diffuser removed (FIG. 3b) and with the diffuser fitted (FIG. 3c);

FIG. 4 shows schematic illustrations of various embodiments of a lamp in a perspective side view (FIG. 4a) and along the section A-A of the illustration shown in FIG. 4a (FIG. 4b); and

FIG. 5 shows a schematic illustration of various embodiments of a luminaire.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments develop a conventional lamp or a conventional luminaire in such a way that the modification of a parameter of the radiation emitted by at least one light emitting diode (LED) is made markedly simpler for a user.

Various embodiments are based on the knowledge that this is made possible in a particularly simple manner when a first housing part and a second housing part of the lamp or luminaire are moved relative to one another in order to modify at least one parameter of the radiation emitted by the at least one LED. Specifically in the case of reading or desk lamps and luminaires, this represents a considerable additional value for a user. For example, the user sees the result of a dimming operation implemented thereby directly at the position at which he is at that instant. In contrast to conventional dimming apparatuses which are fitted near a door, for example, and which cannot be operated from a work station or reading position, a user of various embodiments may adjust the brightness desired by him precisely as he desires because the result can be seen directly. Conventionally, the user needed to first go to the door, make the change to the dimming level, go back to the work station, check that this dimming level is correct, possibly correct the dimming level by going back to the door again, returning and so on and so forth. There is no need for this in various embodiments. Furthermore, a lamp or luminaire according to various embodiments does not need to continuously be in a standby mode since e.g. desk and reading lamps and luminaires generally have an on/off button in the vicinity of the lamp or luminaire. As a result, a user can first switch on the lamp or luminaire and immediately afterwards perform the desired dimming. No unnecessary energy is therefore wasted in a standby mode, as is the case for lamps or luminaires from the prior art with remote control. Moreover, there is no remote control which could easily be mislaid.

In various embodiments, the first housing part is arranged rotatably relative to the second housing part. Therefore, if dimming is performed by a rotary operation, the risk of the lamp or luminaire being shifted or even being knocked over is markedly reduced. It is of course possible, as an alternative, in the case of lamps and luminaires with a sufficient weight for provision also to be made for the first housing part to be arranged so as to be capable of moving translatorily relative to the second housing part. As a further alternative, pushbuttons can be provided, for example a pushbutton for increasing the dimming level, another pushbutton for lowering the dimming level.

In various embodiments, the motion detection sensor may include an angular position detector, which is coupled to the first housing part and the second housing part in order to detect the magnitude of a rotation of the first housing part with respect to the second housing part. Such angular position detectors are very robust and not very susceptible to faults, for example as a result of dust. In various embodiments, very precise adjustment may be performed by means of a rotary movement, in comparison to a translatory movement.

In this context, the angular position detector may include a rotary potentiometer or a capacitive rotary sensor.

The at least one parameter of the at least one light emitting diode (LED) may represent the brightness, such as has already been performed in the past using the example of dimming the at least one LED. However, it may also represent the wavelength of the radiation emitted by the at least one LED. For example when the lamp or the luminaire comprises a plurality of LEDs, different color temperatures or even different colors can thus be set, as desired by the user.

The lamp may furthermore include a switch for switching on and off the lamp. This may provide the advantage that a user does not need to search for a switch on the wall or on the floor or on a cable in order to switch on the lamp. In various embodiments, the switch may include a first switch element, which is coupled to the first housing part, and a second switch element, which is coupled to the second housing part, the first switch element being coupled to the first housing part and the second switch element being coupled to the second housing part in such a way that a switching operation can be triggered by a relative movement of the first housing part with respect to the second housing part. This may open up the possibility of combining switching on/off of the lamp and the modification of the at least one parameter of the radiation emitted by the at least one LED from the point of view of a user. If, for example, the first switch element and the second switch element are designed and arranged in such a way that a switching operation can be triggered by a rotational movement, provision can be made for the lamp to be switched on by the beginning of the rotational movement and for the dimming level of the lamp to be changed by a continuation of the rotational movement. Correspondingly, provision can be made for the first switch element and the second switch elements to be designed and arranged in such a way that a switching operation can be triggered by a translatory movement. In various embodiments, provision may be made for the lamp to be switched on by the beginning of the translatory movement and for the dimming setting of the lamp to be changed by a continuation of the translatory movement.

In various embodiments, the first housing part may include an operating part, by means of which the first housing part can be moved by an operator with respect to the second housing part. In this case, it may be advantageous if the operating part is designed and arranged in such a way that the temperature of the operating part remains below 50° C. during operation of the lamp. Thus, it is also possible for a change to be made to the at least one parameter of the radiation emitted by the at least one LED without any injury during full operation.

In various embodiments, the lamp may include a diffuser and/or a polymer ring, the operating part comprising the diffuser and/or the polymer ring. In this context, the diffuser may likewise be formed from a polymer since this provides the possibility of safer operation than when the diffuser is formed from glass.

In accordance with various embodiments, the second housing part may include a lampholder. This part of the lamp may thus be fixed, with the result that an operator can perform a relative movement of the first housing part with respect to said second housing part using one hand.

In accordance with various embodiments, the first housing part may include a first printed circuit board with electronic components arranged thereon and a second printed circuit board, on which the at least one LED is arranged, the first printed circuit board and the second printed circuit board being coupled to the first housing part in such a way that the first printed circuit board and the second printed circuit board are moved concomitantly during a movement of the first housing part relative to the second housing part. In this way it may be possible in a particularly simple manner for an angular position detector for detecting a rotary movement to be fitted by virtue of one part of the angular position detector being arranged on the first printed circuit board and a second part with the fixed second housing part.

Alternatively, the second housing part may include a printed circuit board, on which the at least one LED is arranged, the printed circuit board being coupled to the second housing part in such a way that the printed circuit board is not moved concomitantly during a movement of the first housing part relative to the second housing part. This may provide the advantage that the printed circuit board on which the at least one LED is arranged can be connected permanently to a heat sink without the heat sink needing to concomitantly rotated in order to modify the at least one parameter of the radiation emitted by the at least one LED.

In this context, the operating part may include an adjusting wheel, which is arranged between the printed circuit board and a diffuser and is coupled in rotationally fixed fashion to the diffuser, the adjusting wheel having cutouts, into which webs of a heat sink, which is coupled to the printed circuit board, engage, the cutouts and webs being dimensioned such that a rotational movement of the diffuser relative to the heat sink through a predeterminable angular range is possible. By virtue of such an arrangement, firstly the printed circuit board can be fixedly connected to the heat sink, and secondly a rotational movement, which can be evaluated by the electronics of the lamp, can be performed reliably by rotation of the diffuser.

In accordance with a further alternative, the first housing part may include a diffuser and a printed circuit board, at least the at least one LED being arranged on the printed circuit board, the diffuser having a protrusion, which engages through the printed circuit board such that the protrusion is rotatable in the event of rotation of the diffuser. Such an arrangement may have the disadvantage, however, that the rotatable protrusion of the diffuser can result in a shadow being cast; however, such an arrangement is characterized by a particularly simple construction.

The various embodiments proposed with respect to a lamp apply correspondingly, where applicable, to a luminaire according to the various embodiments in which the at least one LED is coupled directly to the luminaire, i.e. without the provision of a lamp.

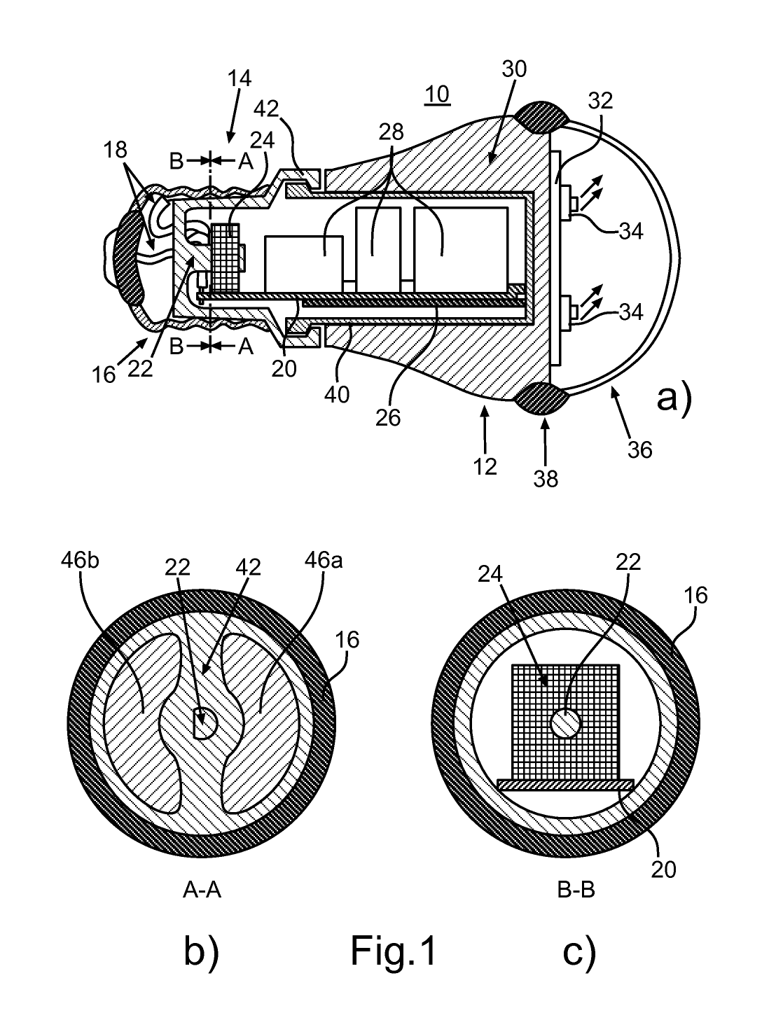

FIG. 1 shows different schematic illustrations of a various embodiments of a lamp 10. Said lamp may include a first housing part 12, which is arranged rotatably with respect to a second housing part 14. The first housing part 12 includes a screw base 16, in which lines 18 are arranged which are coupled firstly to two different terminals of the screw base 16 and to a first printed circuit board 20. The first housing part 12 may furthermore include a receiving element 22 for a rotary potentiometer 24 arranged on the printed circuit board 20. The printed circuit board 20 is coupled in rotationally fixed fashion to the second housing part 14 via guide rails 26. By way of example, some components 28 of the driver electronics for at least one LED 34 are illustrated on the printed circuit board 20. The first housing part 12 includes a heat sink 30, on which a printed circuit board 32 is arranged, LEDs 34 being arranged on the printed circuit board 32, of which two LEDs are illustrated by way of example. A diffuser 36, which is fastened to the heat sink 30 by means of a polymer ring 38, is arranged over the LEDs 34. The first housing part 12 may include a first element 40 of a rotary coupling, while the second housing part 14 includes a second element 42 of the rotary coupling, which interacts with the first element 40.

FIG. 1b shows an illustration along the section A-A from FIG. 1a. The figure clearly shows the receiving element 22, on which the rotary potentiometer 24 is arranged. The receiving element 22 and the rotary potentiometer 24 form a motion detection sensor for detecting the magnitude of a rotation of the first housing part 12 relative to the second housing part 14. Openings 46a, 46b for passing through the cables 18 in order to make contact between said cables and the printed circuit board 20 are clearly shown.

FIG. 1c shows a view of the cross section of the section B-B in FIG. 1a. The rotary potentiometer 24 which is arranged on the receiving element 22 and for its part is arranged on the printed circuit board 20 is shown clearly.

Function: the lamp 10 is designed mechanically such that it integrates an on/off switch and a dimming apparatus. The actuation of both the on/off switch and the dimming apparatus is performed via reciprocal rotation of the first housing part 12 with respect to the second housing part 14. For this purpose, an operator uses either the diffuser 36 or the polymer ring 38 as operating part in order to rotate the first housing part 12 with respect to the second housing part 14. For this purpose, the diffuser 36 is preferably formed from a polymer. In order that the potentiometer 24 can be picked up by the rotary movement, the position of the printed circuit board 20, which is coupled to the first housing part 12, needs to be defined via the guide rails 26. The precisely complementary arrangement of the receiving element 22 and the rotary potentiometer 24 with respect to the first housing part 12 and the second housing part 14 is likewise possible of course.

The housing parts 12, 14 may be rotated with respect to one another through a predeterminable angle, for example 180°. The position of the housing parts 12, 19 with respect to one another is picked up by the rotary potentiometer 24 and passed on to the driver electronics 28 as a measure of the dimming level to be adjusted. Said driver electronics include a dimming apparatus which is coupled to the rotary potentiometer 24 and is designed to modify the brightness emitted by the LEDs 34 depending on the detected magnitude of the rotary movement. In this case, the rotary mid-point of the rotary potentiometer 24 is positioned centrally in the first housing part 12 in the illustrated embodiments. The receiving element 22 of the second housing part is inserted into this rotary mid-point of the rotary potentiometer 24 during fitting. The receiving element 22 can also be part of the rotary potentiometer 24.

Provision can also be made for the lamp 10 to be in a standby mode without any light emission in the rotary position in which the minimum level of the rotary potentiometer 24 is reached. However, provision can also be made for the rotary potentiometer 24 to include an additional integrated switch in the end position with which the lamp 10 can be switched on and off, in addition to the continuous regulation range. This switch may be arranged separately from the regulation terminals of the potentiometer 24, with the result that it can completely interrupt the voltage supply. This may ensure that the lamp 10 does not draw any energy while it is switched off.

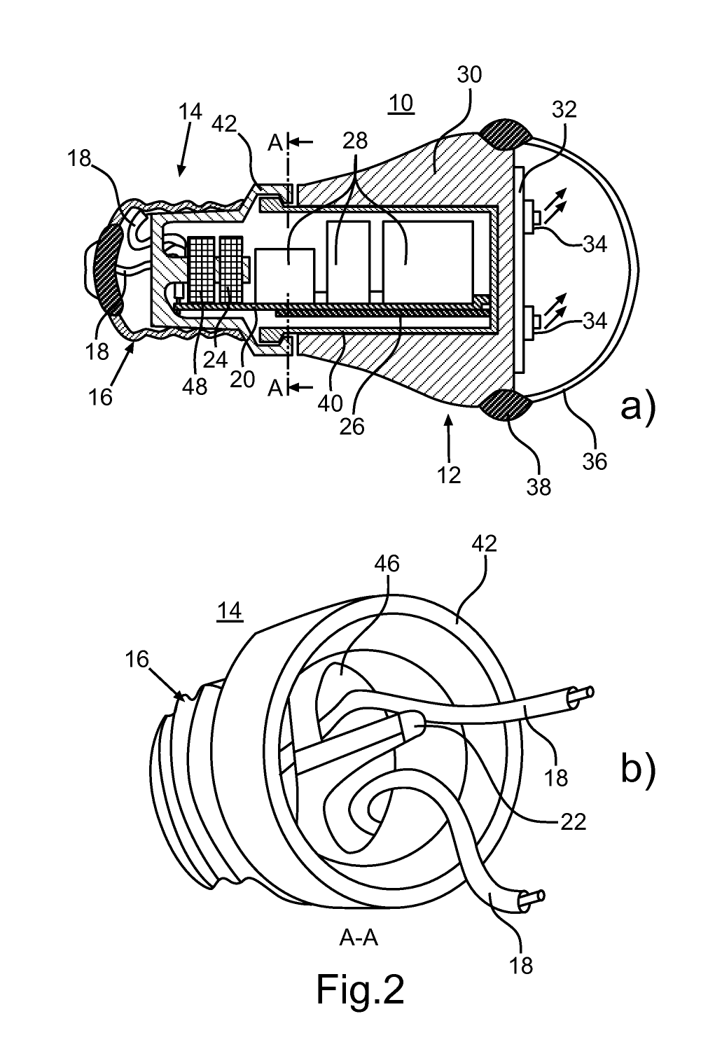

FIG. 2a shows, in a schematic illustration, a longitudinal section through various embodiments of a lamp 10, in which, in comparison with the embodiments shown in FIG. 1a, an additional separate on/off switch 48 is provided, which can isolate the rotary potentiometer 24 and the driver electronics 28 completely from the voltage supply. In this case, this on/off switch 48 has the same design as the rotary potentiometer 24 and is positioned and fitted together therewith.

As an alternative to this, provision may be made for a part which is coupled in rotationally fixed fashion to the second housing part 14 to act in the end position on the printed circuit board 20 in order to form an on/off switch. This may be a spring-actuated switch, for example, which interacts with a tab coupled to the second housing part 14, wherein, in the end position, the spring-actuated switch is lifted by the tab and thus interrupts the voltage supply.

FIG. 2b shows a schematic perspective illustration along the section A-A from FIG. 2a. It can be seen that the lines 18 are passed through an opening 46 in the second element 42. In order to make it possible to rotate the first housing part 12 with respect to the second housing part 14, the lines 18 need to be designed with play and flexibly.

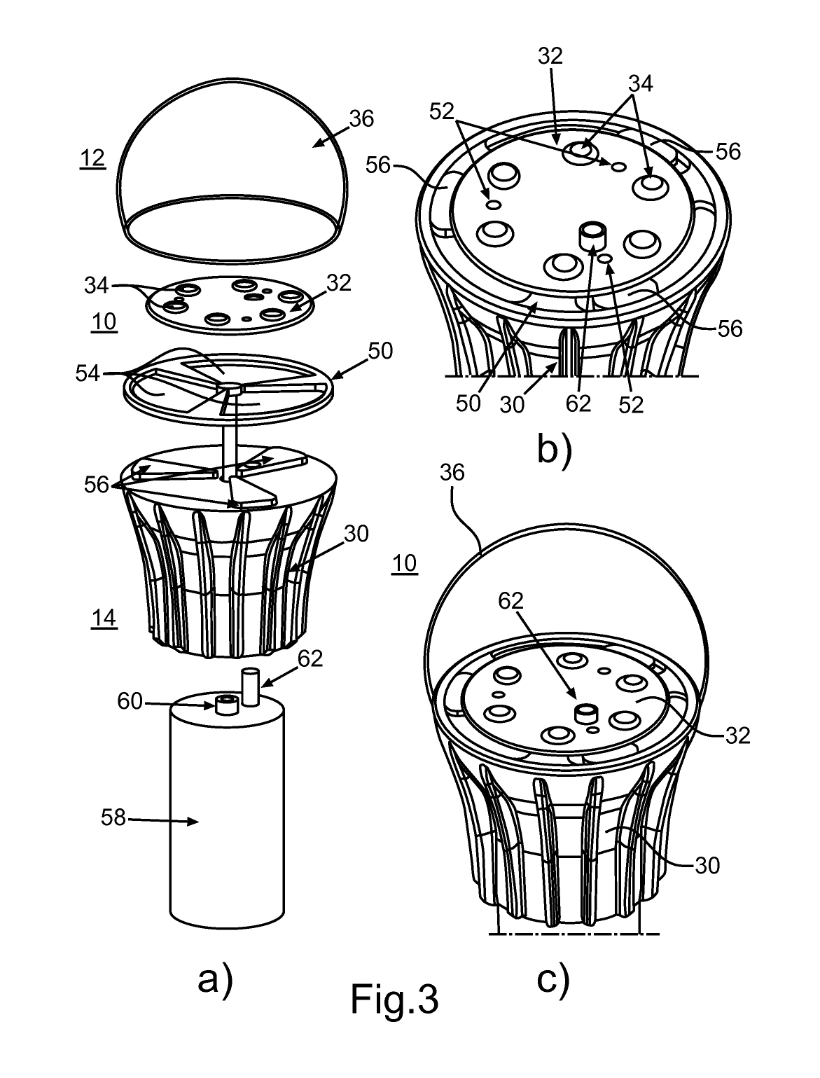

FIG. 3a shows an exploded illustration of part of various embodiments of a lamp 10. In this case, the diffuser 36 is coupled to an adjusting wheel 50, for example by means of a snap-fit or adhesive bonding, the adjusting wheel 50 being mounted rotatably beneath the printed circuit board 32. The printed circuit board 32 is screwed to the heat sink 30 at three points 52 provided for this purpose, as a result of which, firstly, excellent heat dissipation is ensured and, secondly, the construction is kept stable enough for forces acting on the diffuser 36 from the outside to be withstood. In the embodiments shown in FIG. 3, the printed circuit board 32 may be in the form of a metal-core printed circuit board. If, instead, an insulating ceramic printed circuit board is used, this may have a metal plate beneath it in order to intercept the forces acting on the diffuser 36 and to provide good thermal contact with respect to the heat sink 30. In this case, the adjusting wheel 50 has three cutouts 54, which interact with three webs 56 of the heat sink 30 and thus provide the possibility of good thermal coupling of the printed circuit board 32 to the heat sink 30. At the same time, a rotation of the adjusting wheel 50 through up to 90° is thus made possible.

A housing element 58, which has been inserted into the heat sink 30, has two channels 60, 62, the electrical coupling to the LEDs 34 being produced via the channel 62, and the rotatable adjusting wheel 50 being mechanically connected to the inner sensor 24 via the other channel 60.

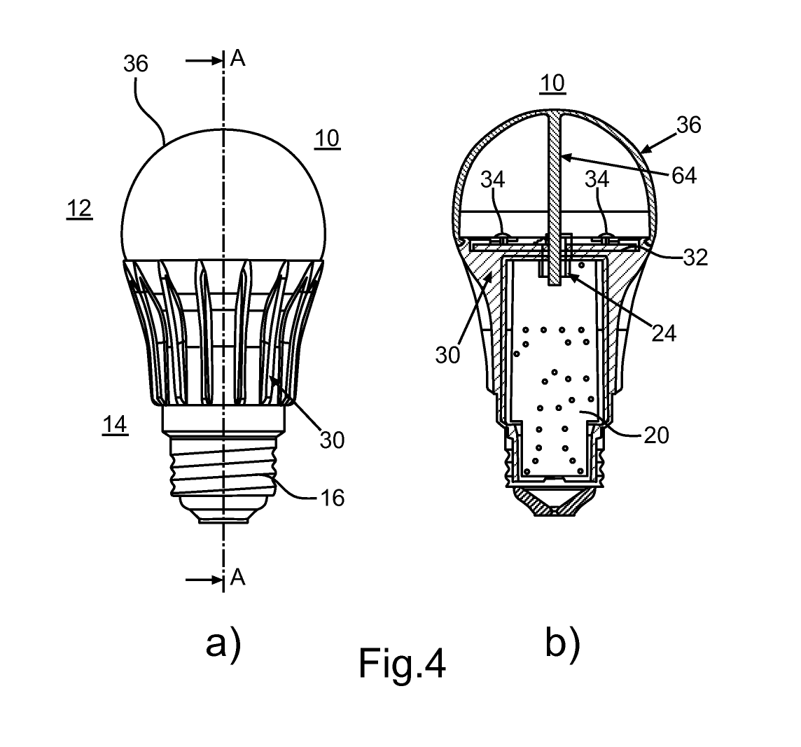

FIG. 4a shows a plan view of a schematically illustrated further embodiment of a lamp 10. In this context, FIG. 4b shows a view along the section A-A from FIG. 4a. Said figure shows that the diffuser 36 has a centrally arranged protrusion 64, which extends through a cutout in the printed circuit board 32 and is coupled to the rotary potentiometer 24 arranged on the printed circuit board 20 for detecting a rotary movement. The diffuser 36 is mounted rotatably with respect to the heat sink 30 for this purpose.

In order to facilitate operation for a user, a symbol can be arranged on the respective operating element, i.e. e.g. the diffuser 36 or the polymer ring 38, or in the vicinity thereof, said symbol being, for example, an arrow, which indicates the rotary direction for dimming the lamp. Provision may be made here for the housing, the adjusting wheel or else also the corresponding switch to have a latching function in order to identify the switching position, in order to make the switch-on or switch-off position clearly recognizable for a user.

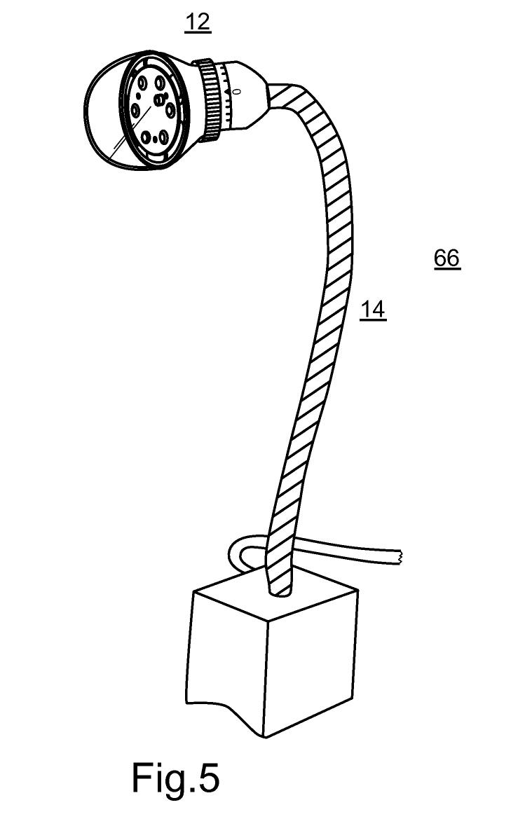

FIG. 5 shows various embodiments of a luminaire 66, in which the first housing part 12 can correspond to the first housing part 12 of the embodiments illustrated in FIG. 1 to FIG. 4 of a lamp 10. The second housing part 14 in this case may include a swan neck and may be coupled rotatably to the first housing part 12. The LEDs 34 are coupled permanently, i.e. without a lampholder, to the first housing part 12, and are therefore not replaceable. This is possible in respect of the long life of the LEDs 34 used as light-emitting means. In the embodiments of a luminaire 66 illustrated in FIG. 5, a user can adjust firstly the brightness and secondly the emission direction of the LEDs 34 by means of a handle.

In an embodiment (not illustrated), a switching function is realized by virtue of pressure being applied to the first housing part 12, with the result that said housing part is shifted in translatory fashion with respect to the second housing part 14. Provision may be made here for it to be possible for the brightness to be adjusted after a first switching operation by rotation of the first housing part 12 with respect to the second housing part 14, for the wavelength of the radiation emitted by the LEDs 34 to be adjusted, for example by a color temperature from blue white to warm white, after a second actuation of the switch. However, provision may also be made for serially implemented switching operations to be used in order to be able to adjust the intensity of the radiation which is emitted by different LEDs, for example R, G, B.

As is obvious to a person skilled in the art, combinations of the various described embodiments are possible.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lamp, comprising:
at least one light emitting diode;
a housing, which comprises at least a first housing part and a second housing part, wherein the first housing part is arranged movably relative to the second housing part;
a motion detection sensor for detecting a magnitude of a movement of the first housing part relative to the second housing part; and
a radiation modification apparatus for modifying at least one parameter of the radiation emitted by the at least one light emitting diode, the radiation modification apparatus being coupled to the motion detection sensor, the radiation modification apparatus being designed to modify the radiation to be emitted by the at least one light emitting diode depending on the detected magnitude of the movement.

2. The lamp as claimed in claim 1,
wherein the first housing part is arranged rotatably relative to the second housing part.

3. The lamp as claimed in claim 2,
wherein the motion detection sensor comprises an angular position detector, which is coupled to the first housing part and the second housing part in order to detect the magnitude of a rotation of the first housing part with respect to the second housing part.

4. The lamp as claimed in claim 3,
wherein the angular position detector comprises a rotary potentiometer or a capacitive rotary sensor.

5. The lamp as claimed in claim 1,
wherein the at least one parameter of the at least one light emitting diode represents at least one of the brightness and the wavelength of the radiation emitted by the at least one light emitting diode.

6. The lamp as claimed in claim 1, further comprising:
a switch for switching on and off the lamp.

7. The lamp as claimed in claim 6,
wherein the switch comprises a first switch element, which is coupled to the first housing part, and a second switch element, which is coupled to the second housing part,
the first switch element being coupled to the first housing part and the second switch element being coupled to the second housing part in such a way that a switching operation can be triggered by a relative movement of the first housing part with respect to the second housing part.

8. The lamp as claimed in claim 7,
wherein the first switch element and the second switch element are designed and arranged in such a way that a switching operation can be triggered by a rotational movement.

9. The lamp as claimed in claim 7,
wherein the first switch element and the second switch element are designed and arranged in such a way that a switching operation can be triggered by a translatory movement.

10. The lamp as claimed in claim 1,
wherein the first housing part comprises an operating part, by means of which the first housing part can be moved by an operator with respect to the second housing part.

11. The lamp as claimed in claim 10,
wherein the operating part is designed and arranged in such a way that the temperature of the operating part remains below 50° C. during operation of the lamp.

12. The lamp as claimed in claim 10,
wherein the lamp comprises at least one of a diffuser and a polymer ring,
the operating part comprising the at least one of the diffuser and the polymer ring.

13. The lamp as claimed in claim 1,
wherein the second housing part comprises a lampholder.

14. The lamp as claimed in claim 1,
the first housing part comprises a first printed circuit board with electronic components arranged thereon and a second printed circuit board, on which the at least one light emitting diode is arranged,
the first printed circuit board and the second printed circuit board being coupled to the first housing part in such a way that the first printed circuit board and the second printed circuit board are moved concomitantly during a movement of the first housing part relative to the second housing part.

15. The lamp as claimed in claim 1,
wherein the second housing part comprises a printed circuit board, on which the at least one light emitting diode is arranged, the printed circuit board being coupled to the second housing part in such a way that the printed circuit board is not moved concomitantly during a movement of the first housing part relative to the second housing part.

16. The lamp as claimed in claim 15,
wherein the operating part comprises an adjusting wheel, which is arranged between the printed circuit board and a diffuser and is coupled in rotationally fixed fashion to the diffuser, the adjusting wheel having cutouts, into which webs of a heat sink, which is coupled to the printed circuit board, engage, the cutouts and webs being dimensioned such that a rotational movement of the diffuser relative to the heat sink through a predeterminable angular range is possible.

17. The lamp as claimed in claim 1,
wherein the first housing part comprises a diffuser and a printed circuit board, at least the at least one light emitting diode being arranged on the printed circuit board,
the diffuser having a protrusion, which engages through the printed circuit board such that the protrusion is rotatable in the event of rotation of the diffuser.

18. A luminaire, comprising:
at least one light emitting diode; and
a housing, which comprises at least a first housing part and a second housing part,
wherein the first housing part is arranged movably relative to the second housing part;
a motion detection sensor for detecting a magnitude of a movement of the first housing part relative to the second housing part; and
a radiation modification apparatus for modifying at least one parameter of the radiation emitted by the at least one light emitting diode,
the radiation modification apparatus being coupled to the motion detection sensor,
the radiation modification apparatus being designed to modify the radiation to be emitted by the at least one light emitting diode depending on the detected magnitude of the movement.
